(19) United States
(12) Patent Application Publication
(10) Pub. No.: US 2003/0107475 A1
(43) Pub. Date: Jun. 12, 2003

(54) Receiver for and method of extending battery life

(76) Inventors: Edwin Espanola Bautista, Chesapeake, VA (US); Edgar Herbert Callaway JR., Boca Raton, FL (US); Frederick Lee Martin, Plantation, FL (US); Stanley Wrzesinski, Arlington Heights, IL (US)

Correspondence Address: POSZ & BETHARDS, PLC, 11250 ROGER BACON DRIVE, SUITE 10, RESTON, VA, 20190, US

(21) Appl. No.: 10/020,334

(22) Filed: Dec. 12, 2001

(51) Int. Cl. H04Q 7/14

(52) U.S. Cl. 340/7.35

(57) ABSTRACT

A method for and selective call communications unit (CU) arranged and constructed for extended battery life includes a first receiver having low power consumption, preferably operating an a duty cycle, for receiving a call signal to provide an enable signal, in one aspect conditioned on a match of a selective call address to an address for the CU; and a messaging receiver, activated by the enable signal, for receiving a message intended for the CU. These methods can result in a battery life for the CU approaching a shelf life of the battery.

### FIELD OF THE INVENTION

This invention relates in general to communication systems, and more specifically to methods and apparatus for extending battery life in communications units within such systems.

### BACKGROUND OF THE INVENTION

Modem communications products need to be relatively small in size and low in weight, easily installed and activated, often portable, user friendly, and relatively maintenance free and at the same time relatively feature rich with low latency availability of complex processing capabilities suitable, for example, for dealing with high speed signaling with sophisticated modulation and error correction procedures. The size and weight and user friendliness objectives suggest that a very small readily available battery such as AAA or the like cell should be used. The maintenance free, easy installation and activation requirements suggest that a very long battery life is needed.

Current selective call receivers with more or less requisite processing capacities have demonstrated battery life from days for cellular receivers to 1-2 months for some messaging devices, which is insufficient. These receivers presently use a duty cycle comprising a periodic scheduled short on or wake cycle followed by a long off or sleep cycle to extend battery life to these levels. Even at the duty cycles being used the latency or delay associated with service availability is generally believed to be marginal for some applications and unacceptable in others. Very low power consumption receivers that are known such as regenerative or passive receivers do not have the sophistication, performance, or processing capabilities needed for most present day applications. Clearly a need exists for selective call communications units with improved and extended battery life.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, a simplified system level diagram of a selective call communications system suitable for utilizing the present invention;

FIG. 2 illustrates in block diagram form, a preferred embodiment of a selective call communications unit in accordance with the present invention;

FIG. 3 depicts, in block diagram form, one preferred embodiment of a low power receiver according to the present invention; and

FIG. 4 shows a flow chart of a preferred method embodiment according to the present invention.

### DETAILED DESCRIPTION OF PREFERRED EMBODIMENT

In overview form the present disclosure concerns communications systems that provide services to communications units or more specifically concerns the selective call communications units operating therein. More particularly various inventive concepts and principles embodied in methods and apparatus for improving or extending battery life for communications units without unduly effecting service availability in such communications systems or networks are discussed. The communications systems of particular interest are those being deployed and developed, such as point to multipoint systems, such as modern or future broadcast and messaging systems, or systems that may follow a mesh architecture, operating in an ad-hoc manner to form links amongst peers and thus collectively a network or both in the form of a hybrid system. Other “systems” of interest are characterized as one on one where mere proximity of one communications unit to another may initiate communications exchanges.

Such systems may operate in frequency bands up to 80 GHz and often under unlicensed ISM frequency allocations and rules. Often they are suited for wireless packet data communications systems and may be expected to employ IP addressing techniques including IPv6. To-date mobility with continuity of service within such systems is limited to relatively small geographic areas. Sometimes “pervasive RF” is used to describe the systems of interest in that many things we may not presently associate with wireless communications would be so equipped and have either remote control or monitoring capability and responsibilities. Generally the activity or traffic patterns for the selective call communications units in many of these systems would be characterized with very long periods of inactivity, perhaps weeks, even months, with an occasional relatively brief period of possibly intense activity for receiving and perhaps responding to one or more varying length and substance messages.

As further discussed below various inventive principles and combinations thereof are advantageously employed to extend battery life. These principles arise from and take advantage of the observation that selective call systems must perform two types of communications functions, one being setting up a connection with a desired recipient and the second transferring whatever information is of interest. The first function will likely determine latency for services. This first function will also determine battery life as most units spend the vast majority of their service life in this mode. From this observation and the principles that arise various solutions to certain problems that adversely effect battery life have been invented. These solutions advantageously facilitate setting up connections, sessions or links with or between selective call units or groups of units and still show improved battery life provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Some of the inventive functionality and inventive principles may best be implemented with or facilitated by software programs or instructions or simple hardware. It is expected that one of ordinary skill, notwithstanding possibly significant effort and many design choices motivated by, for example, available time, current technology, and economic considerations, when guided by the concepts and principles disclosed herein will be readily capable of generating such software instructions and programs or simple hardware with minimal experimentation. Therefore further discussion of such software and hardware, if any, will be limited in the interest of brevity and minimization of any risk of obscuring the principles and concepts in accordance with the present invention.

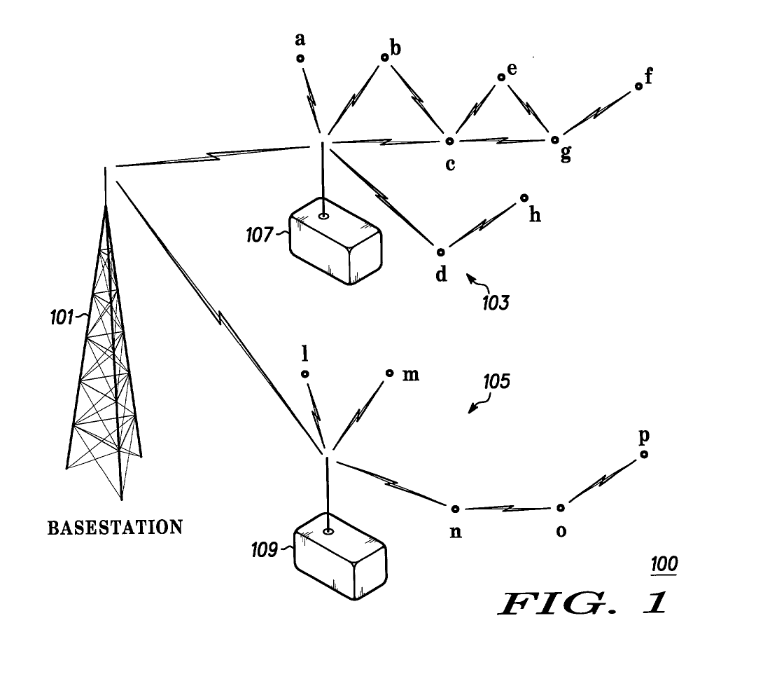

FIG. 1 depicts a simplified system level diagram of a selective call communications system 100 suitable for utilizing the present invention. It is expected that a discussion of FIG. 1 will help provide some common language as well as familiarize the reader with some of the problems of present systems and some of the opportunities envisioned by the principles and concepts according to the present invention. Included in the system 100 is a base station 101 coupled in a suitable wireless manner to a multiplicity of clusters (two shown) 103, 105 of selective call wireless communications units (SCUs) a-p. The clusters 103, 105 are each served by a selective call SCU 107, 109, respectively, that operates in a point to multipoint mode (PMP) mode with certain of the other selective call SCUs within its respective cluster in order to provide access from the base station to these other SCUs and in those instances where the SCUs also have transmit capability access from the SCU to the base station and thus perhaps various wide area networks such as the PSTN or Internet.

The SCUs would be expected to be deployed one or more per household or other location and are at the same time subscriber units and can be peer units capable of setting up links between each other as required on an ad-hoc basis. SCUs such as a, f, h, l, m, and p may be receive only units. This network can use code division, time division, or frequency division multiple access technologies but will be described herein in terms of a time division duplex system. The system can use one or more known modulation techniques and protocols for the various stack levels. For example, the Institute of Electrical and Electronics Engineers (IEEE) 802.15.3 or 802.15.4 standards, now being defined, describe a system operating in the 2.4 GHz frequency band. The 802.15.3 standard is considering direct sequence spread spectrum phase shift keying (DSSS PSK) for the physical layer. By using multi-level modulation and coding, data rates of 20 Mbps or more may be selected based on the signal to noise ratio of the channel. The present disclosure in addition to whatever underlying technologies are utilized for messaging exchanges further envisions a call signal being imposed or available on the normal or at least a channel as we will further discuss below.

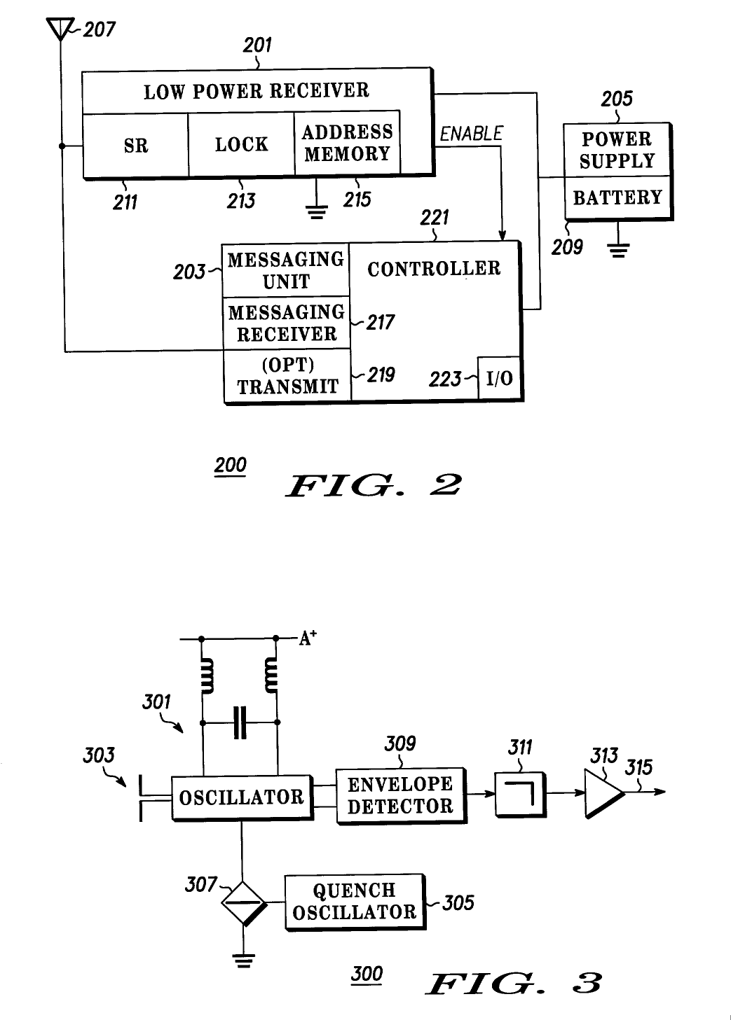

FIG. 2 illustrates in block diagram form, a preferred embodiment of a selective call communications unit (SCU) 200 in accordance with the present invention. The SCU 200 would be suitable for any of the SCUs or subscriber units in FIG. 1, namely 107,109, a-p. The SCU is arranged and constructed to provide service in a hybrid network including PMP portions and mesh portions such as the network 100 of FIG. 1. The SCU is further arranged and constructed for extended battery life in those instances where messaging activities are limited. The SCU includes a low power receiver 201 and a messaging receiver or unit 203 both supplied with power from a battery based power supply 205 further including a battery that in one embodiment would, preferably be an ordinary AAA primary cell. Both receivers are shown coupled to a common antenna 207 although in practice each can have a separate antenna particularly adapted for their respective receivers. For example the low power receiver may be an ultrasonic receiver and what is shown as an antenna would be a transducer or microphone.

The low power receiver 201 is shown in one preferred embodiment to include a super regenerative receiver (SR) 211 coupled to some logic circuitry 213 that is further coupled to an address memory 215. Generally the receiver 201 takes advantage of the ultra low power consumption of known SR receivers and low power consumption logic to operate in a low power consumption manner for receiving a call signal to thus provide an enable signal that is coupled to the messaging unit 203 as depicted. This enable signal is used to activate or enable the messaging receiver that, responsive to the enable signal, receives one or more messages intended for the selective call communications unit.

The messaging unit 203 has a comparatively large power consumption due to the relative sophistication that is often required for high data rate, complex equalization, decoding, security overhead, and other signal processing that are required for many over the air protocols that are being deployed or developed. The messaging unit 203 includes a messaging receiver 217 coupled to a controller 221 and optionally a transmitter 219. The messaging receiver 217 operates to receive signals from and the transmitter 219 for transmitting or sending signals, coupled from or to the antenna system or common antenna 207, to other SCUs, base stations or the like in the system or network. The messaging receiver 217 and transmitter 219 may utilize known radio frequency technologies. The optional transmitter would be required for two-way applications such as many of the nodes within FIG. 1 but not required for broadcast applications such as conventional paging systems.

The controller is shown with an input output (I/O) 223 that provides an appropriate and known interface to a user or other device that utilizes the messaging unit and this may include keys, display apparatus, sensors, actuators, or ports as needed. The controller 221 will include some combination (none specifically shown) of a processor and memory and interface circuitry as required. The processor will ordinarily include a general purpose a microprocessor and a digital signal processor that are widely available from manufacturers such as Motorola and Texas Instruments. The memory is, preferably, comprised of a combination of RAM, ROM, PROM, and rarely magnetic memory all as is known. The memory will include software instructions and parameters that when executed and utilized by the processor causes the controller to control the receiver and transmitter and I/O to receive and send (including coding, modulation, equalization, and the like) signals from other WCUs in accordance with the protocols and other operational conventions that will depend on the particular application, system, or network.

The SCU 200 and specifically low power receiver 201 although depicted using a preferred super regenerative receiver can also utilize a regenerative receiver or a tuned radio frequency (RF) receiver or in other variations an ultrasonic receiver, or passive receiver and the corresponding techniques. These types of receivers are known in various forms. The super regenerative receiver will be discussed further with reference to FIG. 3 below. The regenerative receiver is a variation of that where operating with many of the same principles but ordinarily has slightly higher power consumption or current drain with possibly lower cost. The regenerative receiver, in comparison to the super regenerative receiver, also suffers from low sensitivity and the need for careful tuning of the regeneration control, which makes user-friendly operation more difficult. As is known in the art, both receivers are capable of receiving AM and FM transmissions making them useful in many applications. For example, both of these receivers have been used in keyless entry systems and garage door openers.

The tuned RF receiver, as its name implies, is a receiver in which all amplification and filtering takes place with tuned RF amplifiers without conversion to base band or a lower intermediate frequency. These receivers while simple to construct, are difficult to stabilize and the rejection of unwanted signals is difficult to achieve, limiting their practicality in the modern congested RF spectrum.

The ultrasonic receiver uses a simple transducer or microphone, rather than or as an antenna, to pick up and amplify a 30 to 50 kHz signal and provide a logic output when such a signal is detected. This receiver can be low current drain/low power consumption since it is essentially a transducer and very low power op amp followed by an envelope detector all of which operate at relatively low frequencies..

Passive receivers are basically no power consumption devices or devices that derive whatever power they may need from an externally supplied signal. These units have a very limited range. The passive receiver would be useful variant if near proximity (2 meters) was one criteria for communicating with the SCU. The passive receiver has been used in radio frequency identification tag technology. An example of a passive receiver is the known crystal receiver.

In the preferred form if one SCU or base station wishes to communicate with the SCU 200 it will first transmit a call signal on a channel appropriate for the particular low power receiver being used and thereafter send messages in the proper form on the channel. Preferably, the call signal will be an amplitude modulated signal, for example, a 1-0 pattern or a tone modulation. A preferred frequency for this pattern or tone is 32.768 kHz, although it is possible to use a frequency modulated signal, transmitted on the same channel or within the same bandwidth that is used for messages or communications. This call signal will last sufficiently long for low power receivers within range to receive and decode the tone or pattern. In one variation receiving the tone will result in an enable signal being provided to the messaging receiver. In another and preferred variation detecting this call signal will result in the low power receiver staying on to receive a further start of frame code word and thereafter a selective call address. If this selective call address matches or correlates with an address for the SCU 200 stored in memory 215 the enable signal is generated.

To further reduce or lower power consumption the selective call communications unit or the low power receiver can take advantage of or operate according to a duty cycle including a down or sleep time period and an up or awake time period, where the down time period exceeds the up time period. This technique and variants of it are used in traditional paging and messaging systems. To use this technique the logic 213 would include timers that awake or power up the SR receiver upon lapse of perhaps a sleep timer and upon lapse of an awake timer the SR receiver would be powered down. The longer the sleep period is compared to the wake period the lower average power consumption will be. Of course the sleep period cannot be any longer than the systems worst-case latency allows.

When the low power receive or SR receiver is awake or powered up it will operate to receive the call signal, preferably an AM modulated signal (possibly an FM modulated signal) when one is present on the channel and, in one form, will remain powered up to detect a selective call address. Again once the selective call address is received the low power receiver will compare it to an address for the selective call communications unit and when the address matches provide the enable signal and when the address does not match resumes operation according to the duty cycle.

The messaging receiver for the SCU 200 is preferably a super heterodyne (SH) receiver but could as well be a zero or low intermediate frequency receiver, or a delay line receiver. The super heterodyne receiver as is known is one where the carrier signal frequency is translated one or more times to a lower intermediate (IF) frequency where the modulation on the carrier, now IF, signal is recovered. The zero or low IF frequency receiver is a form of SH receiver, wherein the carrier frequency is translated to or near to a zero IF frequency signal. The delay line receiver is a variant of the tned RF receiver, in which multiple tuned RF amplification stages are separated by delay structures, usually surface acoustic wave (SAW) devices. The RF stages are activated in sequence with the arriving signal, thereby amplifying it. However, since no two stages are active at any one time the stability problem of the tuned RF receiver is overcome (at the expense of added SAW devices).

In any event the messaging receiver having been activated by the enable signal after an appropriate warm up time period of 0.1-10 milliseconds will operate to receive the messages, specifically a protocol arranged for messaging purposes, such as a direct sequence spread spectrum phase shift keyed modulation. Generally these messages are sent as a combination of a short preamble, for symbol synchronization purposes, followed by the address of the transmitting or originating device, other header information such as packet length and message type and then the message itself. Using these inventive techniques, simulations have shown an expected battery life that is advantageously on the order of the shelf life for a typical AAA primary cell.

In the variation where the low power receiver immediately after detecting the AM modulated call signal provides the enable signal, the messaging receiver, activated by the enable signal, will receive a selective call signal and detect a selective call address included therewith. Again if a comparison shows that the address matches an address for the SCU the messaging receiver will remain powered up to receive messages and if there is no match power back down until another enable signal is provided. Note in this example it is likely that the address would be stored in the controller 221. Also it is known to provide a processor with varying power consumption states and it may be advantageous to construct the SCU 200 where all logic and memory is part of a common controller that then controls the low power receiver and messaging unit and provides address comparisons and so on.

FIG. 3 depicts, in block diagram form, one preferred embodiment of a low power receiver, specifically a super regenerative receiver (SR). As these receivers are known this explanation will be very brief. Basically an oscillator 301 is coupled to an antenna 303. The oscillator is relatively high Q in large part determined by the depicted inductors and will oscillate at or near the carrier frequency when enabled by the quench oscillator 305 coupled to the oscillator at 307. When a carrier signal is available at the antenna the amplitude of the oscillations of oscillator 301 will increase according to the amplitude of the carrier signal. The envelope detector 309 coupled to the oscillator will detect the envelope and provide a larger signal when the carrier is available than when it is not, thereby performing AM demodulation. After low pass filtering at 311 and amplifying at 313 the SR receiver will provide a signal at 315 indicative of the presence of the amplitude of a carrier signal at the antenna. Thus an AM modulated signal is readily detected.

As a brief review we have discussed and described a selective call communications unit that is arranged and constructed for extended battery life. The SCU includes a first receiver having low power consumption for receiving a call signal to provide an enable signal; a messaging receiver, activated by the enable signal, for receiving a message intended for the selective call communications unit; and optionally a transmitter, activated by the enable signal for responding to the message. The SCU includes a battery based power supply for powering the first receiver, the messaging receiver, and the transmitter wherein an expected battery life is on the order of a shelf like for a battery included in the battery based power supply.

The first or low power receiver is, preferably, a super regenerative receiver that receives an amplitude modulated signal and thereafter remains active to receive a selective call address. Further included in the SCU is a comparator and so on for comparing the selective call address with an address for the selective call communications unit and when the address matches providing the enable signal. An alternative arrangement is for the enable signal to be provided upon detection of the amplitude modulated signal and the messaging receiver, thus activated, receives the selective call address and does the comparison and when there is a match receives the message for the SCU.

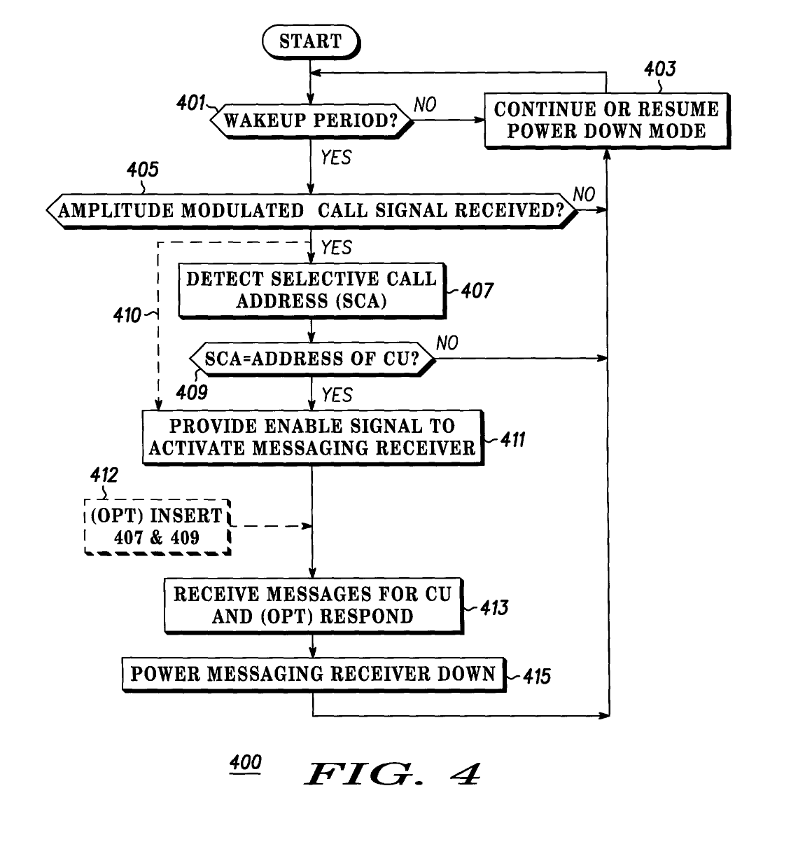

FIG. 4 shows a flow chart of a preferred method embodiment according to the present invention. A review of FIG. 4 will serve largely as a summary of certain of the basic processes, generally discussed above, that are occurring according to the principles and concepts of the present disclosure. The method 400, preferably occurs in a selective call communications unit (CU) and is method of extending battery life for the CU. In one embodiment the expected battery life will be on the order of the shelf life of a battery included in a battery based power supply that is provided for the CU provided the principles and concepts taught in the present disclosure are practiced.

As an overview the method shows first receiving a call signal, preferably, using a first receiver having a low power consumption mode and this resulting in providing an enable signal. As noted above this receiving the call signal in the low power consumption mode, preferably uses one of a super regenerative processes, a regenerative processes, a tuned radio frequency processes, ultrasonic processes, and a passive receiving processes and the corresponding receiver type.

Thereafter the process includes receiving, responsive to the enable signal and in a second power consumption mode, using a messaging receiver, a message intended for the selective call communications unit. It is anticipated that the second power consumption mode will be greater and likely much greater than the first power consumption mode. This receiving the message in a second power consumption mode, preferably uses one of super heterodyne processes, a zero intermediate frequency processes, a low intermediate frequency processes and a delay line processes and the corresponding receiver type.

In more detail and with reference to FIG. 4 the process, preferably starts at 401 where a test to see whether the first receiving step or first receiver from FIG. 2 is in a wakeup period. Part of the low power consumption mode includes, preferably, operating according to a duty cycle that includes a down time or sleep time period that may be relatively long and an up time or wake time period that may be relatively short, such that the down time period exceeds the up time period, preferably significantly. If it is not a wake period 403 indicates that a sleep or power down condition continues or is resumed and the process returns to step 401. If it is a wake period the process using a first receiver in a low power consumption mode will listen for or attempt to receive a call signal and step 405 tests whether the call signal, preferably an amplitude modulated or frequency modulated signal, has been received. If not the process returns to step 403.

If the call signal is received at step 405 the first receiver will stay powered up or awake and after sensing a unique start of frame code word or packet will receive and detect a selective call address (SCA) at 407. Step 409 then tests or compares the received SCA to an address for the CU. If the SCA does not match the address the process returns to step 403 and the first receiver resumes a power down or sleep mode or operating according to the duty cycle. If there is a match an enable signal is provided at 411 and this used to activate, wakeup, or enable the messaging receiver.

Note: the dotted line 410 and dotted box 412. In a further aspect the method 400 after detecting or receiving the amplitude modulated call signal can immediately provide the enable signal thus activating the messaging receiver and the messaging receiver would then perform the steps of detecting the SCA and comparing it to the address for the CU represented by steps 407 and 409 and both receivers would resume the sleep or power down mode if the SCA did not match. In practice whether the first receiver or the messaging receiver is used to detect and compare the SCA will depend on the relative complexity of the SCA, etc.

In any event after step 411 at 413 the process receives, responsive to the enable signal and in a second power consumption mode using the messaging receiver, a message intended for the selective call communications unit. This receiving the message will include a protocol arranged for messaging purposes, such as a direct sequence spread spectrum phase shift keyed modulated signal. The CU can optionally respond as required if a transmitter is included with the CU. It is anticipated that the second receiving the message will consume more power than the first receiving the call signal.

The processes, discussed above, and the inventive principles thereof are intended to and will alleviate problems with battery life caused by or suffered by prior art selective call communications units. Using these principles of using an ultra low power consumption receiver for detecting a connection attempt and only thereafter enabling a higher power consumption and more complex messaging receiver for the information transfer is expected to yield battery lives as long as the shelf life of a battery in some circumstances, thus facilitating pervasive radio connectivity for today and tomorrows consumers.

Various embodiments of methods and apparatus for providing or facilitating the providing of services in a communications network in a battery efficient manner have been discussed and described. It is expected that these embodiments or others in accordance with the present invention will have application to paging and messaging systems as well as many wireless local area networks that provide connectivity for devices or communications units as well as such networks that are coupled to fixed or wired WANS such as the PSTN or internet. The disclosure extends to the constituent elements or equipment comprising such systems and specifically the methods employed thereby and therein. Using the inventive principles and concepts disclosed herein advantageously allows or provides for low latency and long battery life which will be beneficial to users and providers of communications services.

This disclosure is intended to explain how to fashion and use various embodiments in accordance with the invention rather than to limit the true, intended, and fair scope and spirit thereof. The invention is defined solely by the appended claims, as may be amended during the pendency of this application for patent, and all equivalents thereof.

What is claimed is:

1. A selective call communications unit arranged and constructed for extended battery life comprising in combination:
a first receiver having low power consumption for receiving a call signal to provide an enable signal; and
a messaging receiver, activated by said enable signal, for receiving a message intended for the selective call communications unit.

2. The selective call communications unit of claim 1 wherein said first receiver is one of a super regenerative receiver, regenerative receiver, tuned radio frequency receiver, ultrasonic receiver, and passive receiver.

3. The selective call communications unit of claim 2 wherein said first receiver operates according to a duty cycle including a down time period and an up time period, said down time period exceeding said up time period.

4. The selective call communications unit of claim 2 wherein said first receiver receives said call signal and remains powered up to detect a selective call address.

5. The selective call communications unit of claim 4 wherein said first receiver compares said selective call address to an address for the selective call communications unit and when said address matches provides said enable signal and when said address does not match resumes operation according to said duty cycle.

6. The selective call communications unit of claim 1 wherein said call signal includes one of an amplitude modulated signal and a frequency modulated signal.

7. The selective call communications unit of claim 1 wherein said messaging receiver is one of a super heterodyne receiver, a zero intermediate frequency receiver, a low intermediate frequency receiver and a delay line receiver.

8. The selective call communications unit of claim 1 wherein said messaging receiver activated by said enable signal receives a protocol arranged for messaging purposes.

9. The selective call communications unit of claim 8 wherein said messaging protocol uses a direct sequence spread spectrum phase shift keyed modulation.

10. The selective call communications unit of claim 7 wherein a power consumption of said messaging receiver exceeds a power consumption of said first receiver.

11. The selective call communications unit of claim 1 further including a battery based power supply to power said first receiver and said messaging receiver, wherein an expected battery life is on the order of a shelf life for a battery included in said battery based power supply.

12. The selective call communications unit of claim 7 wherein said messaging receiver activated by said enable signal receives a selective call signal and detects a selective call address.

13. A method in a selective call communications unit of extending battery life, the method including the steps of:
first receiving a call signal using a first receiver to provide an enable signal in a first low power consumption mode; and
second receiving, responsive to said enable signal and in a second power consumption mode using a messaging receiver, a message intended for the selective call communications unit.

14. The method of claim 13 wherein said first receiving said call signal in said first low power consumption mode uses one of a super regenerative processes, regenerative processes, tuned radio frequency processes, ultrasonic processes, and passive receiving processes.

15. The method of claim 13 wherein said first receiving said call signal in said first low power consumption mode includes operating according to a duty cycle including a down time period and an up time period, said down time period exceeding said up time period.

16. The method of claim 14 wherein said first receiving said call signal in said first low power consumption mode includes detecting a selective call address.

17. The method of claim 16 wherein said first receiving said call signal in said first low power consumption mode further includes comparing said selective call address to an address for the selective call communications unit and when said address matches providing said enable signal and when said address does not match resuming operation according to said duty cycle.

18. The method of claim 13 wherein said first receiving said call signal in said first low power consumption mode includes receiving one of an amplitude modulated signal and a frequency modulated signal.

19. The method of claim 13 wherein said second receiving said message in a second power consumption mode uses one of a super heterodyne processes, a zero intermediate frequency processes, a low intermediate frequency processes and a delay line processes.

20. The method of claim 13 wherein said second receiving said message includes receiving a protocol arranged for messaging purposes.

21. The method of claim 20 wherein said receiving said protocol includes receiving a direct sequence spread spectrum phase shift keyed modulation.

22. The method of claim 19 wherein said second receiving said message consumes more power than said first receiving said call signal.

23. The method of claim 13 further including providing a battery based power supply wherein an expected battery life is on the order of a shelf life for a battery included in said battery based power supply.

24. The method of claim 19 wherein said second receiving said message includes receiving a selective call signal and detecting a selective call address.

25. A selective call communications unit arranged and constructed for extended battery life comprising in combination:
a first receiver having low power consumption for receiving a call signal to provide an enable signal;
a messaging receiver, activated by said enable signal, for receiving a message intended for the selective call communications unit; and
a transmitter, activated by said enable signal for responding to said message.

26. The selective call communications unit of claim 1 further including a battery based power supply for powering said first receiver, said messaging receiver, and said transmitter wherein an expected battery life is on the order of a shelf like for a battery included in said battery based power supply.

27. The selective call communications unit of claim 1 wherein said first receiver is a regenerative receiver that receives an amplitude modulated signal and thereafter remains active to receive a selective call address.

28. The selective call communications unit of claim 27 further including a comparator for comparing said selective call address with an address for the selective call communications unit and when said address matches provide said enable signal.

29. The selective call communications unit of claim 1 wherein said messaging receiver activated by said enable signal receives a selective call address.

30. The selective call communications unit of claim 29 further including a comparator for comparing said selective call address with an address for the selective call communications unit and when said address matches remain active to receive said message.
